(19) United States
(12) Patent Application Publication
(10) Pub. No.: US 2022/0210143 A1
(43) Pub. Date: Jun. 30, 2022

(54) APPARATUS AND METHOD FOR COMMUNICATING DATA IN IN-VEHICLE NETWORK BASED ON AUTOMOTIVE ETHERNET

(71) Applicant: ELECTRONICS AND TELECOMMUNICATIONS RESEARCH INSTITUTE, Daejeon (KR)

(72) Inventors: Bo-Heung CHUNG, Daejeon (KR); Dae-Won KIM, Daejeon (KR); Sang-Woo LEE, Daejeon (KR); Jin-Yong LEE, Daejeon (KR); Boo-Sun JEON, Daejeon (KR); Hong-Il JU, Daejeon (KR); Joong-Yong CHOI, Daejeon (KR)

(21) Appl. No.: 17/508,888

(22) Filed: Oct. 22, 2021

(30) Foreign Application Priority Data
Dec. 30, 2020 (KR) 10-2020-0187078

(51) Int. Cl. H04L 29/06; H04L 29/08; H04L 9/06

(52) U.S. Cl. CPC H04L 63/08; H04L 9/0643; H04L 63/126; H04L 67/12

(57) ABSTRACT

Disclosed are an apparatus and method for communicating data in an in-vehicle network. The method, performed by apparatuses for communicating data on a transmission side and a reception side, includes determining, by the apparatus on the transmission side, whether data collected from the in-vehicle network is changed; creating, by the apparatus on the transmission side, an authentication value based on the determination as to whether the data is changed, creating a message including the data and the authentication value and transmitting the message to the apparatus on the reception side; receiving, by the apparatus on the reception side, the message; creating, by the apparatus on the reception side, a verification value using data extracted from the message; and verifying, by the apparatus on the reception side, the integrity of the apparatus on the transmission side by comparing the authentication value extracted from the message with the verification value.

### CROSS REFERENCE TO RELATED APPLICATION

This application claims the benefit of Korean Patent Application No. 10-2020-0187078, filed Dec. 30, 2020, which is hereby incorporated by reference in its entirety into this application.

### BACKGROUND OF THE INVENTION

### 1. Technical Field

The present invention relates generally to in-vehicle network communication technology, and more particularly to lightweight secure communication technology that is capable of protecting transmitted messages and authenticating electronic control units (ECUs) in an internal communication process between the electronic control units in an in-vehicle network.

### 2. Description of Related Art

These days, vehicles fused with various technologies, such as Internet-of-Things (IoT), high-speed communication, Artificial Intelligence (AI), and the like, are evolving from simple transportation means into a manner of providing social and cultural benefits to people. In order to accommodate these various technologies, comprehensive analysis based on various kinds of sensing and image information is required. To this end, the need for adopting automotive Ethernet, which is able to provide a broad bandwidth, is rapidly increasing, and attempts to apply automotive Ethernet to vehicles are being made.

The recent in-vehicle network is a hybrid network environment in which an existing legacy network and automotive Ethernet are applied together. In this hybrid network environment, devices are required to frequently communicate with each other using various methods, and one of the most important issues in such a communication process is to ensure the security of communicated data so as to be protected from various threats by identifying a transmission device and performing authentication. However, low-end Electronic Control Units (ECU) are still being used in this environment. Also, messages transmitted and received between such ECUs are characterized in that they are repeatedly transmitted at short intervals and in that they have to be transmitted in real time.

The Controller Area Network (CAN), which is a representative legacy protocol, has a transfer rate of 1 Mbps and uses a packet size of 8 bytes, and CAN with Flexible Data rate (CAN-FD), which is an extended form of CAN, uses a packet size of 64 bytes. When these protocols are used, it is difficult to perform a function requiring a high transfer rate. Also, it is not easy to apply encryption/authentication to existing legacy protocols such as CAN due to characteristics such as a small packet size, broadcast-based transmission, and the like. In order to solve this problem, most approaches are configured to modify the CAN protocol to thereby implement and apply a new protocol enabling authentication, encryption, and the like. Also, in order to authenticate messages and ECUs, ECUs may perform encryption and computationally expensive hashing or operate a Hardware-based Security Module (HSM) by installing the same in the ECUs. However, this method requires the use of a high-specification ECU capable of performing authentication/encryption operations or the use of an HSM capable of performing such operations by attaching the HSM to the ECU. Also, in order to perform encryption, an encrypted message has to be divided into multiple CAN packets before transmission due to the limited packet size of 8 bytes, and the ECU receiving the message needs hardware capable of gathering all of these packets and decrypting the same. Therefore, what is required is a method that does not require additional hardware and is capable of performing identification and authentication of ECUs in a communication process without the use of a special ECU having performance sufficient to perform complex encryption.

Meanwhile, Korean Patent Application Publication No. 10-2020-0061763, titled “Method and apparatus for communication between devices based on automotive Ethernet in in-vehicle network”, discloses a method in which a domain gateway performs communication based on automotive Ethernet in an in-vehicle network.

### SUMMARY OF THE INVENTION

An object of the present invention is to provide secure communication between devices connected to an in-vehicle network and a network service.

Another object of the present invention is to provide a low-cost communication environment between devices connected to an in-vehicle network.

In order to accomplish the above objects, a method for communicating data in an in-vehicle network, performed by apparatuses for communicating data on a transmission side and a reception side in the in-vehicle network, according to an embodiment of the present invention includes determining, by the apparatus on the transmission side, whether data collected from the in-vehicle network is changed based on a preset gap value; creating, by the apparatus on the transmission side, an authentication value based on a determination as to whether the data is changed, creating, by the apparatus on the transmission side, a message including the data and the authentication value, and transmitting, by the apparatus on the transmission side, the message to the apparatus on the reception side; receiving, by the apparatus on the reception side, the message from the apparatus on the transmission side in the in-vehicle network; creating, by the apparatus on the reception side, a verification value using the data extracted from the message; and verifying, by the apparatus on the reception side, integrity of the apparatus on the transmission side by comparing the authentication value extracted from the message with the verification value.

Here, determining whether the data is changed may be configured to determine that the data is changed when the difference between the value of the data and the value of previously collected data is equal to or greater than the gap value.

Here, transmitting the message may be configured to recreate the authentication value only when the data is determined to be changed, and to create a message including the recreated authentication value along with the changed data.

Here, transmitting the message may be configured to change the gap value to a preset next gap value when a number of messages equal to or greater than a preset number is created.

Here, transmitting the message may be configured to create the authentication value by hashing the data using a hash algorithm shared in advance between the apparatus on the transmission side and the apparatus on the reception side.

Here, transmitting the message may be configured to create the authentication value from a value acquired by encrypting the data using a key shared in advance between the apparatus on the transmission side and the apparatus on the reception side.

Here, creating the verification value may be configured to check whether the message includes an authentication value and to create the verification value when the message includes the authentication value.

Here, creating the verification value may be configured to create the verification value by hashing the data using a hash algorithm shared in advance between the apparatus on the transmission side and the apparatus on the reception side.

Here, creating the verification value may be configured to create the verification value from a value acquired by encrypting the data using the key shared in advance between the apparatus on the transmission side and the apparatus on the reception side.

Also, in order to accomplish the above objects, an apparatus for communicating data in an in-vehicle network according to an embodiment of the present invention includes one or more processors and executable memory for storing at least one program executed by the one or more processors. The at least one program is configured to determine whether data collected from the in-vehicle network is changed based on a preset gap value, to create an authentication value based on a determination as to whether the data is changed, to create a message including the data and the authentication value, and to transmit the message to an Electronic Control Unit (ECU) on a reception side in the in-vehicle network.

Here, the at least one program may determine that the data is changed when the difference between the value of the data and the value of previously collected data is equal to or greater than the gap value.

Here, the at least one program may recreate the authentication value only upon determining that the data is changed, and may create the message including the recreated authentication value along with the changed data.

Here, the at least one program may change the gap value to a preset next gap value when a number of messages equal to or greater than a preset number is created.

Here, the at least one program may create the authentication value by hashing the data using a hash algorithm shared in advance with the ECU on the reception side.

Here, the at least one program may create the authentication value from a value acquired by encrypting the data using a key shared in advance with the ECU on the reception side.

Also, in order to accomplish the above objects, an apparatus for communicating data in an in-vehicle network according to an embodiment of the present invention includes one or more processors and executable memory for storing at least one program executed by the one or more processors. The at least one program may be configured to receive a message from an Electronic Control Unit (ECU) on a transmission side in the in-vehicle network, to create a verification value using data extracted from the message, and to verify integrity of the ECU on the transmission side by comparing the verification value with an authentication value extracted from the message.

Here, the at least one program may check whether the message includes an authentication value, and may create the verification value when the message includes the authentication value.

Here, the at least one program may create the verification value by hashing the data using a hash algorithm shared in advance with the ECU on the transmission side.

Here, the at least one program may create the verification value from a value acquired by encrypting the data using a key shared in advance with the ECU on the transmission side.

### BRIEF DESCRIPTION OF THE DRAWINGS

The above and other objects, features, and advantages of the present invention will be more clearly understood from the following detailed description taken in conjunction with the accompanying drawings, in which:

FIGS. 1 to 3 are views illustrating an in-vehicle network environment according to an embodiment of the present invention;

FIG. 4 is a view illustrating a communication process between ECUs in an in-vehicle network according to an embodiment of the present invention;

FIG. 5 is a view illustrating a secure communication process in an in-vehicle network according to an embodiment of the present invention;

FIG. 6 is a view illustrating in detail an example of the configuration of a message for the secure communication process in the in-vehicle network illustrated in FIG. 5;

FIG. 7 is a view illustrating authentication strategies on a case-by-case basis in the secure communication process in the in-vehicle network illustrated in FIG. 5;

FIG. 8 is a view illustrating in detail an example of the configuration of a message for a secure communication process in an in-vehicle network according to the authentication strategy of case 1 illustrated in FIG. 7;

FIG. 9 is a view illustrating in detail an example of the configuration of a message for a secure communication process in an in-vehicle network according to the authentication strategy of case 2 illustrated in FIG. 7;

FIG. 10 is a view illustrating in detail an example of the configuration of a message for a secure communication process in an in-vehicle network according to the authentication strategy of case 3 illustrated in FIG. 7;

FIG. 11 is a view illustrating in detail an example of the configuration of a message for a secure communication process in an in-vehicle network according to the authentication strategy of case 4 illustrated in FIG. 7;

FIG. 12 is a view illustrating messages transmitted and received in a secure communication process in an in-vehicle network according to an embodiment of the present invention;

FIG. 13 is a view illustrating the process of creating an authentication value in a secure communication process in an in-vehicle network according to an embodiment of the present invention;

FIGS. 14 to 16 are views illustrating a secure communication process using authentication information in an in-vehicle network according to an embodiment of the present invention;

FIGS. 17 to 19 are views illustrating a secure communication process using encryption/decryption in an in-vehicle network according to an embodiment of the present invention;

FIG. 20 is a block diagram illustrating a communication apparatus in an in-vehicle network according to an embodiment of the present invention;

FIG. 21 is a flowchart illustrating a communication method in an in-vehicle network according to an embodiment of the present invention;

FIG. 22 is a flowchart illustrating a communication method of an ECU on a transmission side in an in-vehicle network according to an embodiment of the present invention;

FIG. 23 is a flowchart illustrating a communication method of an ECU on a reception side in an in-vehicle network according to an embodiment of the present invention; and

FIG. 24 is a view illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations that have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present invention will be described in detail with reference to the accompanying drawings.

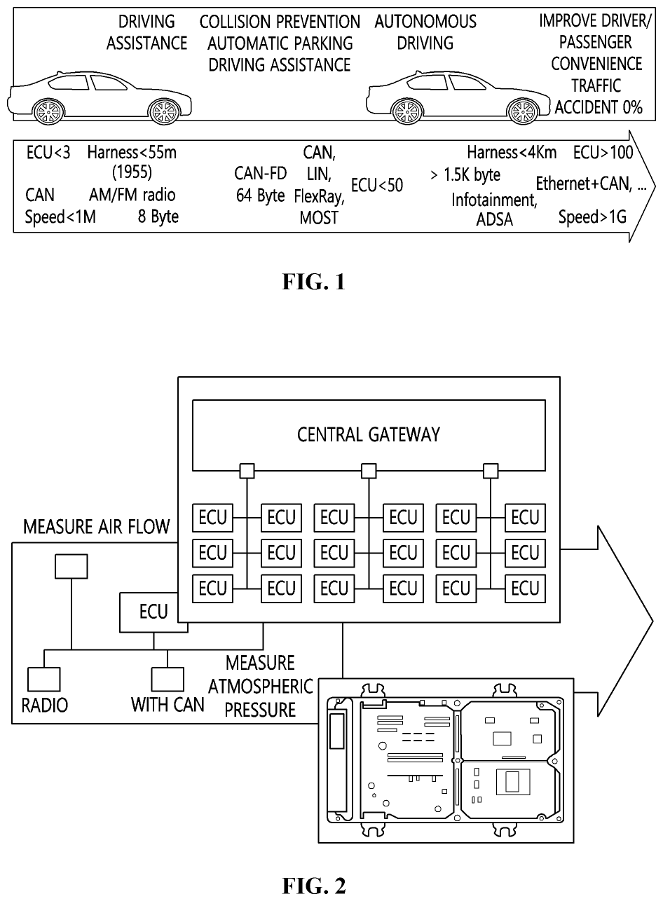

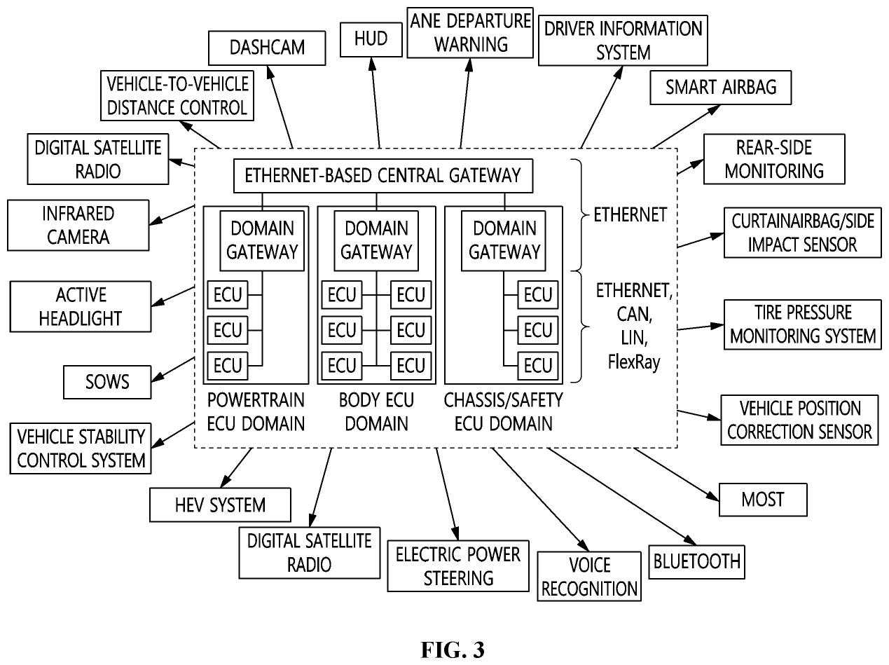

FIGS. 1 to 3 are views illustrating an in-vehicle network environment according to an embodiment of the present invention.

Referring to FIGS. 1 to 3, it can be seen that devices (Electronic Control Units (ECUs)) in a vehicle are connected via a bus through an existing legacy Controller Area Network (CAN) and are managed as a single logical domain in an in-vehicle network environment in which automotive Ethernet is applied according to an embodiment of the present invention.

Here, it can be seen that the ECUs are connected to an external domain (a network outside the vehicle) via a domain gateway or a central gateway.

Here, for the connection to the external domain, the ECUs may be directly connected to the domain gateway of the external domain through automotive Ethernet, or may be connected thereto via the central gateway as needed.

The in-vehicle network environment according to an embodiment of the present invention may correspond to an automotive Ethernet hybrid network (referred to as an automotive hybrid network for brevity), because a legacy network and automotive Ethernet are connected with each other therein.

Accordingly, in order for an ECU included in each domain to deliver data to another domain, CAN packets of the data are delivered to the domain gateway of the domain to which the ECU belongs, the CAN packets are converted to Ethernet packets therein, and the Ethernet packets are delivered to the gateway of the domain to which a destination ECU belongs and are converted back to the CAN packets therein, whereby the data may be finally delivered to the destination ECU.

In the automotive hybrid network, connection methods may be divided into connection to a domain gateway, connection to domain/central gateways, and connection to a central gateway depending on whether a connection to a gateway taking the same role or a connection to a gateway at a hierarchically different level is provided in the network configuration. However, the domain gateway may function as the central gateway or vice versa, and this is a feasible option in the management of the automotive hybrid network. In the present invention, secure communication may be performed in an in-vehicle network using a method of connection to domain/central gateways.

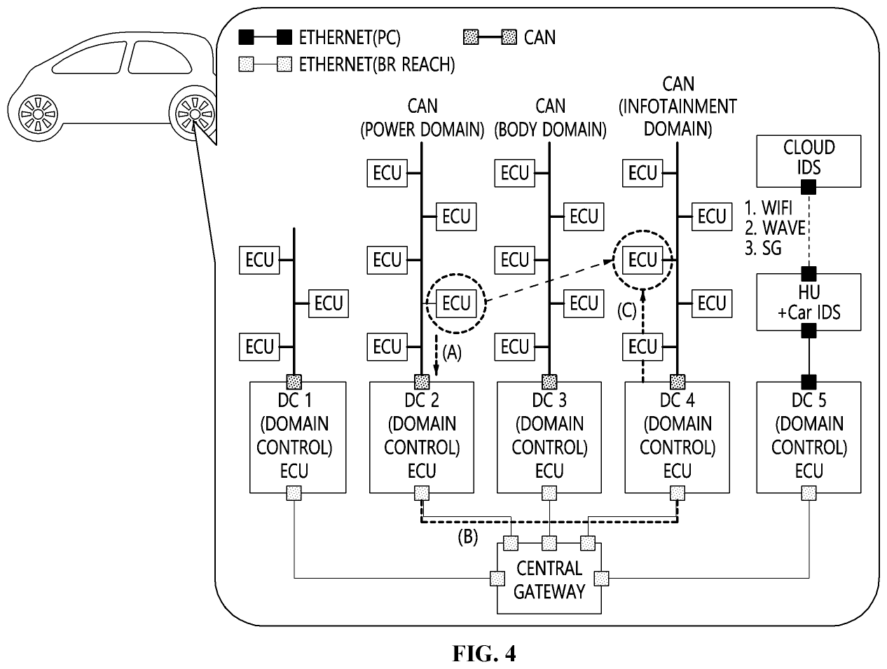

FIG. 4 is a view illustrating a communication process between ECUs in an in-vehicle network according to an embodiment of the present invention.

Referring to FIG. 4, it can be seen that a communication process between ECUs in an in-vehicle network is illustrated. In a hybrid network method in which an in-vehicle network is configured as a hybrid network, as shown in FIG. 4, communication from an ECU on a transmission side to an ECU on a reception side involves passing through various networks and multiple gateways in the order of CAN/LIN, a domain gateway, a central gateway, another domain gateway, and CAN/MOST. Therefore, a security function, such as encryption, is applied, whereby secure communication may be performed in the communication process between ECUs in an in-vehicle network according to an embodiment of the present invention.

For example, communication flow for displaying information about the temperature inside a vehicle on a navigation screen may be configured such that a climate control ECU acquires information (a measured temperature) from a sensor and transmits the same to a domain gateway DC 2 (A), the information is transmitted from the domain gateway DC 2 to a domain gateway DC 4 (B), and the domain gateway DC 4 transmits the information to the final ECU (C). However, in this process, various networks and gateways are involved in communication, which may incur a high cost for applying and operating various elements that need to be considered in order to apply an encryption method for allocating/sharing/distributing keys among devices, a protocol for secure communication settings/management, and the like.

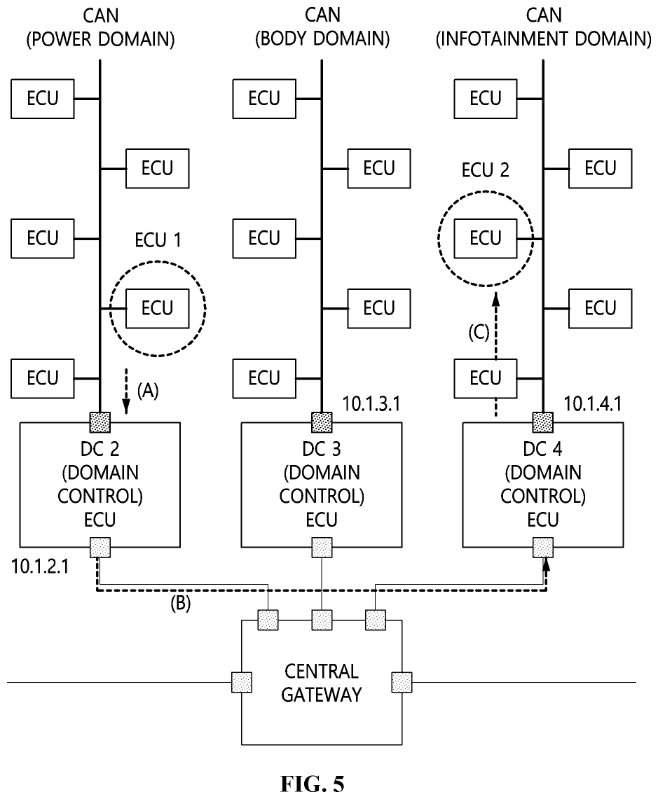

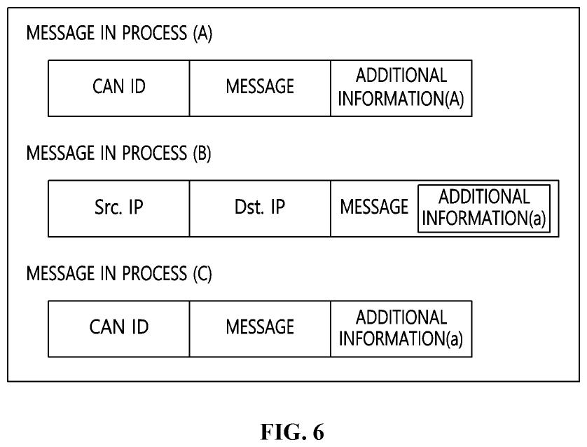

FIG. 5 is a view illustrating a secure communication process in an in-vehicle network according to an embodiment of the present invention. FIG. 6 is a view illustrating in detail an example of the configuration of a message for the secure communication process in the in-vehicle network illustrated in FIG. 5.

Referring to FIG. 5, the process of providing secure communication that enables ECUs to securely communicate with each other by applying security techniques such as authentication, encryption, and the like to the communication process described with reference to FIG. 4 is illustrated in detail.

Assuming that secure communication from a climate control ECU (ECU 1) to a navigation ECU (ECU 2) is performed, three sections, namely sections (A), (B), and (C), are present. For example, if an encryption technique is applied to all of the three sections as a communication method, complexity occurs from various aspects, such as key management, session management, and the like, and this is not an effective method in terms of security.

Also, in addition to the selection of a secure communication method, there is concern about setting the extent of the section to be protected. For example, when it is intended to protect all of the sections, including (A), (B), and (C), using a single authentication method in order to apply a secure communication method, ECU 1 adds additional information (a), which is authentication information, to a CAN message and transmits the CAN message to a domain gateway DC 2 (a source, a gateway having an IP address of 10.1.2.1), as shown in FIG. 6. Subsequently, the domain gateway DC 2 (the source, the gateway having the IP address of 10.1.2.1), which received the CAN message, converts the CAN message into an Ethernet packet and transmits the same to a domain gateway DC 4 (a destination, a gateway having an IP address of 10.1.4.1).

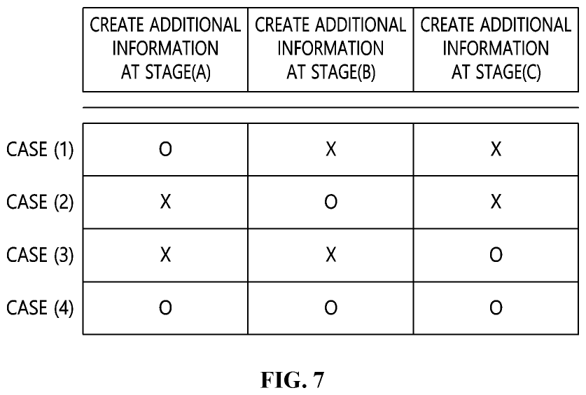

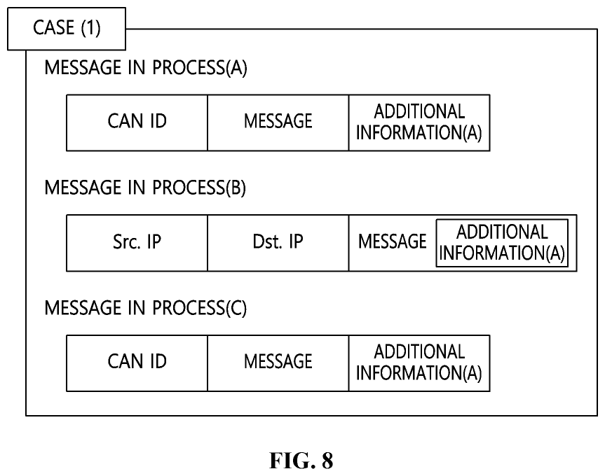

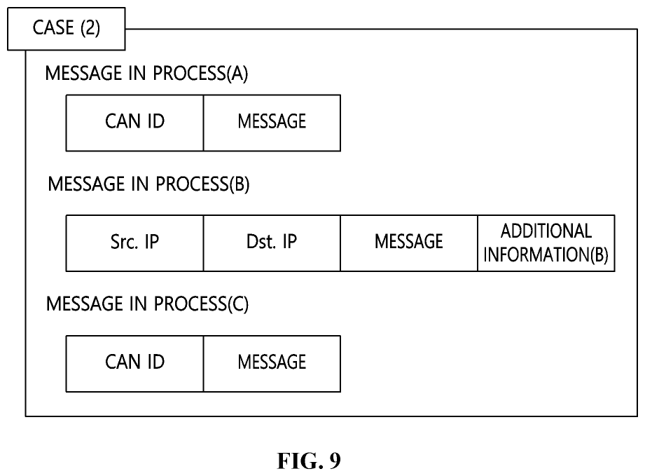

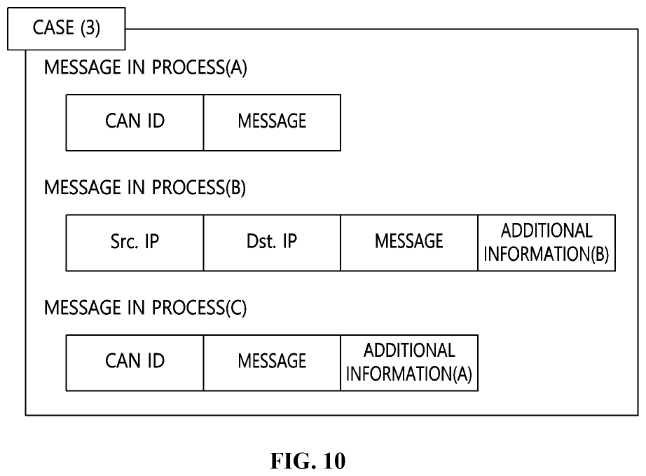

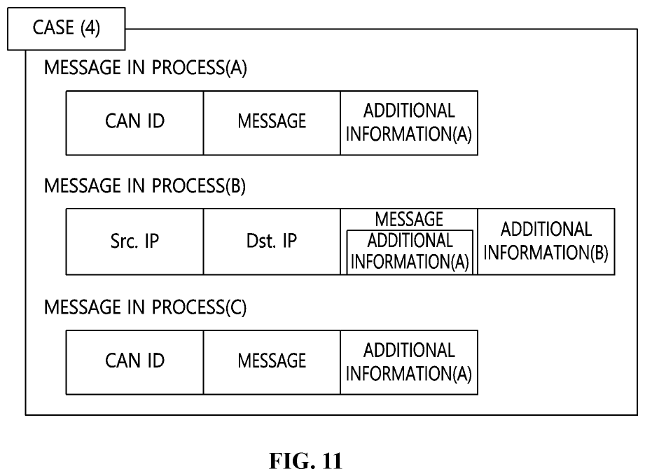

FIG. 7 is a view illustrating authentication strategies on a case-by-case basis in the secure communication process in the in-vehicle network illustrated in FIG. 5. FIG. 8 is a view illustrating in detail an example of the configuration of a message for a secure communication process in an in-vehicle network according to the authentication strategy of case 1 illustrated in FIG. 7. FIG. 9 is a view illustrating in detail an example of the configuration of a message for a secure communication process in an in-vehicle network according to the authentication strategy of case 2 illustrated in FIG. 7. FIG. 10 is a view illustrating in detail an example of the configuration of a message for a secure communication process in an in-vehicle network according to the authentication strategy of case 3 illustrated in FIG. 7. FIG. 11 is a view illustrating in detail an example of the configuration of a message for a secure communication process in an in-vehicle network according to the authentication strategy of case 4 illustrated in FIG. 7.

FIG. 7 illustrates various authentication strategies for responding to an increasing number of various types of attacks and for effectively applying secure communication to a recent in-vehicle network, which has changed from a single CAN network structure to an automotive hybrid network.

Here, as the various authentication strategies, four levels of authentication strategy, namely cases 1, 2, 3 and 4, are progressively applied using context information, such as information about the relationship between respective devices connected to the in-vehicle network, depending on the situation.

Here, the context information may include a network state and mutual trust information between a transmitting ECU and a receiving ECU.

The authentication strategies may be applied in the order of case (2)→case (1) or in the order of case (3)→case (4).

Referring to FIG. 8, when case (1) is applied, additional information is created by ECU 1 only in process (A), whereby the same additional information (a) is transmitted in sections (A), (B), and (C).

Referring to FIG. 9, when case (2) is applied, because additional information is created only in process (B), a message includes no additional information in process (A), and additional information (b) is transmitted between domain gateways only in process (B).

Referring to FIG. 10, when case (3) is applied, additional information is created only in process (C).

Referring to FIG. 11, when case (4) is applied, ECU 1 creates first additional information (first authentication information) and transmits a message to which the first additional information is added, DC 2, which receives the message, creates second additional information (second authentication information), other than the first additional information created by ECU 1, and DC 4 creates third additional information (third authentication information), other than the first additional information and the second additional information, and transmits the same.

That is, because authentication is performed using different pieces of additional information for the respective sections, that is, the section between ECU 1 and DC 2 (ECU 1↔DC 2), the section between DC 2 and DC 4 (DC 2↔DC 4), and the section between DC 4 and ECU 2 (DC 4↔ECU 2), case (4) may be considered enhanced secure communication.

However, if the method of case (4) is simply applied and used, this may impose an excessive load on the in-vehicle network.

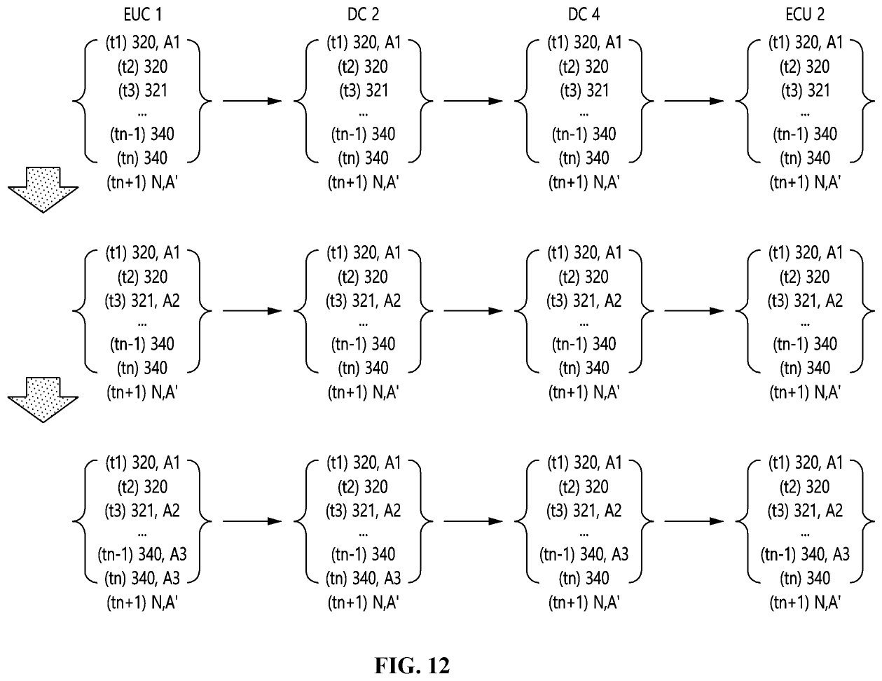

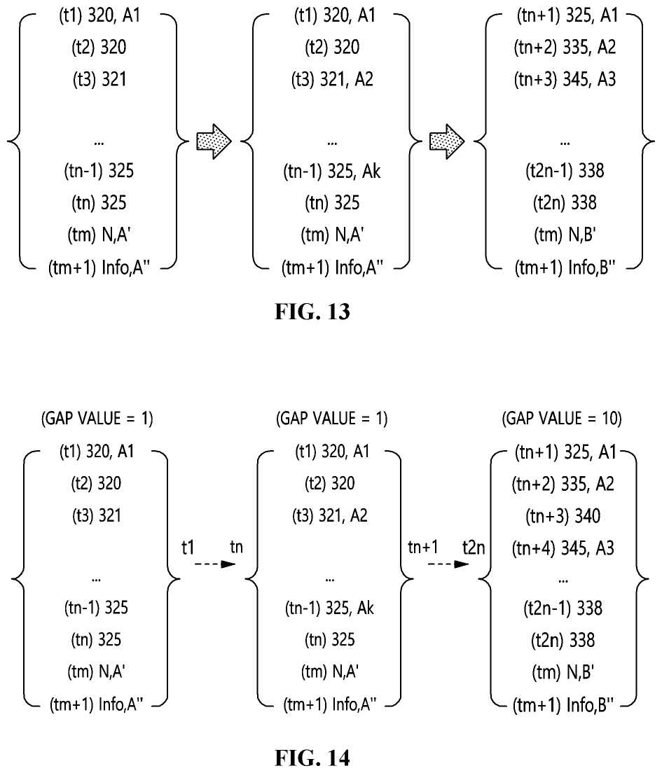

FIG. 12 is a view illustrating messages transmitted and received in a secure communication process in an in-vehicle network according to an embodiment of the present invention. FIG. 13 is a view illustrating authentication information created in a secure communication process in an in-vehicle network according to an embodiment of the present invention.

Referring to FIG. 12, messages transmitted and received in the secure communication process between ECU 1 and ECU 2 (ECU1↔ECU2) in the in-vehicle network described with reference to FIG. 5 are illustrated.

That is, the manner whereby ECU 1, DC 2, DC 4, and ECU 2 send messages and perform authentication over time is illustrated.

As described above, the present invention is configured to perform authentication of a transmitter in order to perform effective secure communication by reducing computationally expensive operations. That is, ECU 2 on the reception side may confirm that the received message is transmitted from a normal ECU 1 on the transmission side, rather than authenticating individual messages therefrom.

First, ECU 1 may transmit a message including data having a value of 320 at time (t1).

Here, ECU 1 may transmit a message that includes an authentication value A1 denoting ECU 1 (additional information).

ECU 2 receives the message and verifies the authentication value A1, thereby confirming that the message was transmitted by ECU 1.

When it transmits a message at time (t2), ECU 1 may not create an additional authentication value, because the message to transmit at time (t2) has the same value as the message transmitted at time (t1).

When it transmits data having a value of 321 at time (t3), ECU 1 may transmit a message after adding an authentication value A2 to the message.

Here, in order to transmit a message to which an authentication value is added when the value of the data to be transmitted is changed, ECU 1 may use a control value (a gap value, GV) for controlling whether to add an authentication value.

When a preset gap value GV is 1 (GV=1), it can be seen that ECU 1 creates a new authentication value A2 at time (t3), because data having a value of 320 at time (t1) is changed to data having a value of 321 at time (t3) and the difference therebetween is 1.

Referring to FIG. 13, the process of creating an authentication value in the secure communication process described with reference to FIG. 12 is illustrated in more detail.

ECU 1 may create an authentication value (I=Hash(Data)) using a hash algorithm shared in advance with ECU 2.

Here, ECU 1 may create a message <Data, I> and transmit the same to ECU 2. As illustrated in FIG. 13, Data is 320, and I is A1.

ECU 2 may compare the authentication value included in the received message with a verification value, and may determine that verification succeeds when the authentication value is equal to the verification value.

That is, ECU 2 may calculate the verification value I′ (I′=Hash(Data)) itself using the data included in the received message and the hash algorithm shared in advance between ECU 1 and ECU 2.

Here, after it checks whether the verification value I′ is equal to the authentication value I, ECU 2 may determine that verification of ECU 1 succeeds when the verification value I′ is equal to the authentication value I, but may determine that verification of ECU 1 fails when the verification value I′ is different from the authentication value I.

In the present invention, an authentication value may be recreated based on the number of messages created until that point in time and a preset control value (gap value), rather than recreating an authentication value whenever a message is transmitted.

For example, an ECU functioning to measure temperature inside a vehicle transmits data acquired by actually measuring the temperature inside the vehicle, and the value of the data has characteristics such that it gradually changes (e.g., 10° C.→12° C.→14° C.) and such that it falls within a specific range (e.g., between −20° C. and 80° C.).

Accordingly, the present invention may apply two options, which are a method of creating a verification value for an individual value (method (a)) and a method of using a previously calculated value (method (b)), in the process of calculating a verification value. The two methods (a) and (b) may be changed depending on different environmental factors, such as a vehicle network configuration, environment settings, tuning of initial settings, and the like, or may be changed depending on the policies of vehicle manufacturers.

Because the two methods (a) and (b) are the same process, excluding values used as seed values, the following description will be made with a focus on the method using a previously calculated value for convenience of description. The method (a) is the sequence of performing creation of data→creation and addition of additional information→transmission→reception→extraction of authentication information→data verification after creation of authentication information, and the method (b) is the sequence of performing creation of pieces of authentication information (in advance)→creation of data→addition of authentication information→transmission→reception→extraction of authentication information→data verification. Accordingly, the method (b) provides verification at lower cost than the method (a), and is suitable when real time transmission is required. The method (a) is suitable when real-time transmission is not strictly required or when thorough data verification is required.

FIGS. 14 to 16 are views illustrating a secure communication process using authentication information in an in-vehicle network according to an embodiment of the present invention.

Referring to FIG. 14, it can be seen that a secure communication process using authentication information in an in-vehicle network according to an embodiment of the present invention is illustrated.

First, a preset number of pieces of information (k pieces of information) may be calculated/created as authentication information Ak, which is used for verification of a transmitter, and may be shared between ECU 1 and ECU 2.

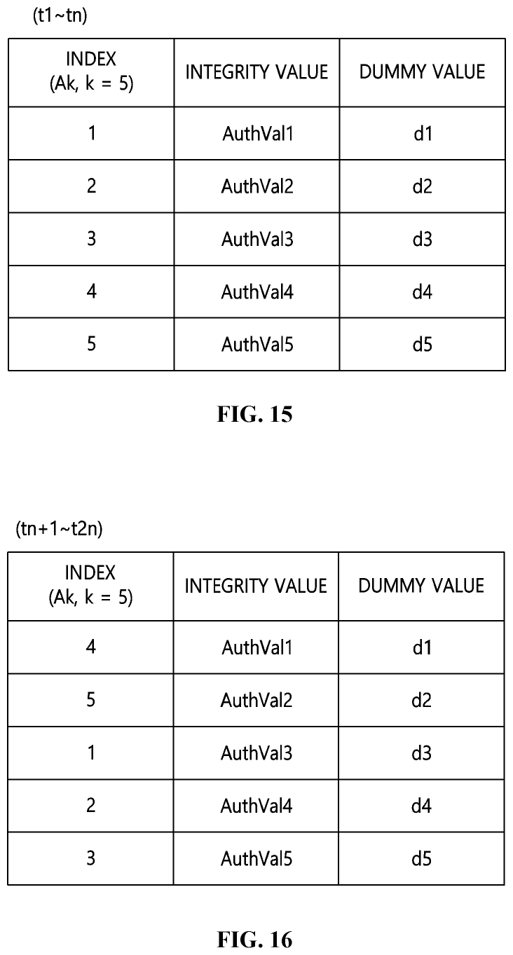

Referring to FIG. 15, authentication information is represented using a table. Here, the present number, k, is 5 (k=5). Also, because an authentication value is newly created when the value of the data to be transmitted is changed, a control value (a gap value GV) based on which a change in the value of the data is monitored and determined is set. The initial gap value is set to 1. However, a change in the data value transmitted from ECU 1 to ECU 2 (ECU 1→ECU 2) may increase over time. For example, referring to FIG. 14, because GV=1 and k=5 are set, when the data value is changed from 320 to 324, processing may be performed using the authentication values shared in advance. However, when the number of pieces of data becomes greater than 5 (k=5), the gap value GV is increased from 1 to 10 (GV=10), and an authentication value A2 is created.

After the gap value GV is changed to 10 (GV=10), the authentication value A1 is added to 325 and transmitted at time (tn+1). If the gap value GV is 1 (GV=1) as before, the authentication value A5 has to be added to 325 and transmitted, but because the gap value GV is changed to 10 (GV=10), the authentication value A1 is transmitted instead, after which there is no need to transmit authentication values when 320 to 329 are transmitted. The drawing shows the case in which, when 335 has to transmitted at time (tn+2), because this data value falls out of the aforementioned range, an authentication value A2 is transmitted by adding the same to 325.

‘N’ is the first transmitted message, and ECU 1 calculates H1=Hash(N, A1), H2=Hash(H1, A), . . . , using the initial data 320 and the authentication value A1, thereby calculating A′=Hash(Hk−1, Ak). ECU 1 transmits A′ after time tn, thereby verifying once more that the process from t1 to tn is performed normally.

‘Info’ denotes control variables, such as a gap value and the like, and ECU 1 calculates A″=Hash(Info, A′), thereby verifying once more that both the process performed so far and the control variables are normal.

Here, when the gap value changes from 1 to 10, the actual values of A1 . . . A5 are changed. Therefore, in order to differentiate the same from A′, B′ and B″ are used.

Referring to FIG. 16, a previously shared authentication value table, which is authentication information, may be vulnerable to attacks if it always contains the same values in spite of a change in the gap value GV. Therefore, indices in the table are forcibly changed, whereby the value A1(Auth1+d1) between t1 to tn is changed to the value A1 (Auth4+d4) between tn+1 to t2n. The dummy values in the table are option values that are settable depending on the vehicle network configuration and the situation.

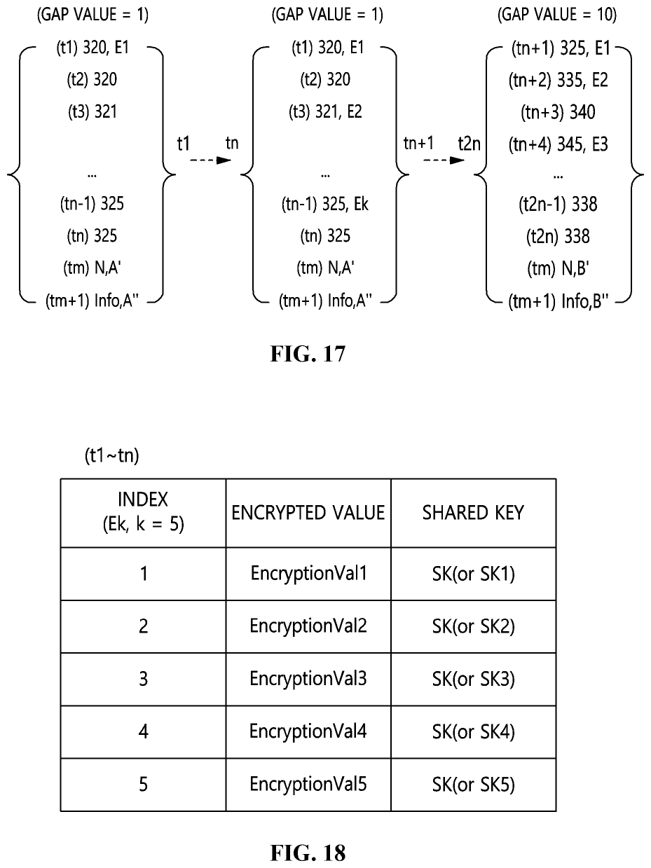

FIGS. 17 to 19 are views illustrating a secure communication process using encryption/decryption in an in-vehicle network according to an embodiment of the present invention.

Referring to FIGS. 17 to 19, it can be seen that a value encrypted with a mutually shared key SK is used as an authentication value, rather than using integrity values in a table as hash values.

Here, ECUs have a shared key SK, which is shared in advance therebetween, and perform encryption using the shared key. The ECUs may use two options, which are a method of transmitting E1 acquired by encrypting the initial value 320 and a method of transmitting previously calculated E1.

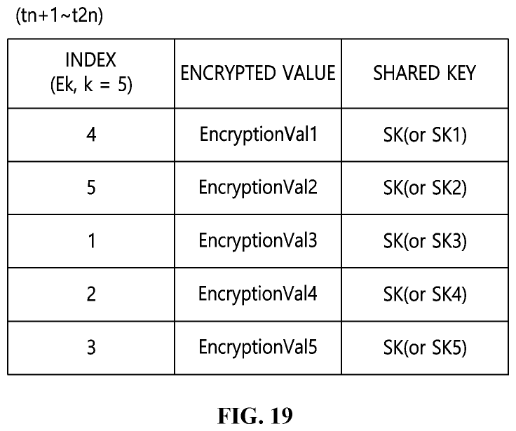

ECUs may share a single shared key, but may share and use k shared keys, for example, SK1, . . . , SK5 as in the tables illustrated in FIGS. 18 and 19, in order to enhance security. That is, ECUs may select the number of shared keys in the tuning process when management is performed.

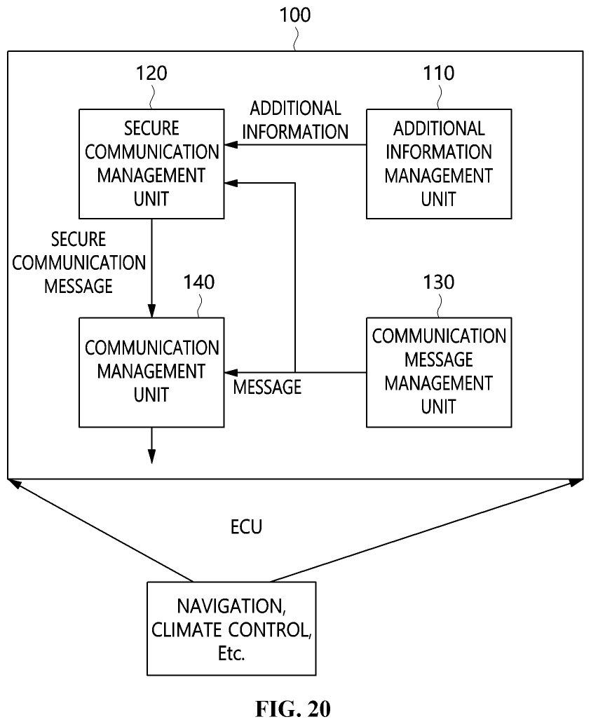

FIG. 20 is a block diagram illustrating a communication apparatus in an in-vehicle network according to an embodiment of the present invention.

Referring to FIG. 20, an ECU, which is a communication apparatus in an in-vehicle network according to an embodiment of the present invention, includes an additional information management unit 110, a secure communication management unit 120, a communication message management unit 130, and a communication management unit 140.

The additional information management unit 110 may determine whether data collected from an in-vehicle network is changed based on a preset gap value, and may create an authentication value depending on the determination as to whether the data is changed.

Here, when the difference between the value of the data and the value of previously collected data is equal to or greater than the gap value, the additional information management unit 110 may determine that the data is changed.

Here, the additional information management unit 110 may recreate an authentication value only when the data is determined to be changed.

Here, when a number of messages equal to or greater than a preset number is created, the additional information management unit 110 may change the gap value to a preset next gap value.

Here, the additional information management unit 110 may create the authentication value by hashing the data using a hash algorithm shared in advance with the ECU on the reception side.

Here, the additional information management unit 110 may create the authentication value from a value that is acquired by encrypting the data using a key shared in advance with the ECU on the reception side.

The secure communication management unit 120 may create a message including the data and the authentication value.

Here, the secure communication management unit 120 may create a message by including the recreated authentication value along with the changed data.

The communication message management unit 130 may transmit the message to the Electronic Control Unit (ECU) on the reception side in the in-vehicle network.

The communication message management unit 130 may receive a message from the Electronic Control Unit (ECU) on the transmission side in the in-vehicle network.

The additional information management unit 110 creates a verification value using data extracted from the message and compares the authentication value extracted from the message with the verification value, thereby verifying the integrity of the ECU on the transmission side.

The secure communication management unit 120 may check whether the message includes an authentication value.

Here, when an authentication value is included in the message, the additional information management unit 110 may create a verification value.

Here, the additional information management unit 110 may create the verification value by hashing the data using a hash algorithm shared in advance with the ECU on the transmission side.

Here, the additional information management unit 110 may create the verification value from a value acquired by encrypting the data using a key shared in advance with the ECU on the transmission side.

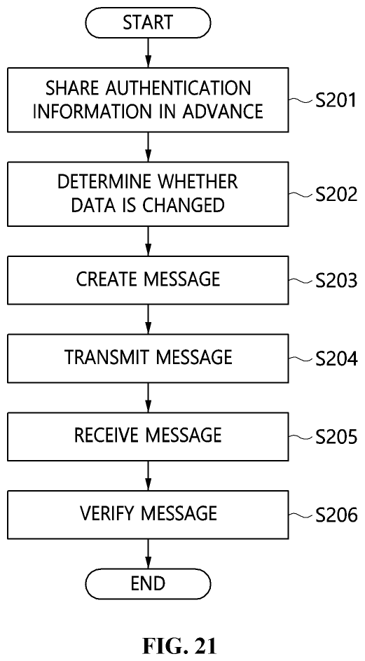

FIG. 21 is a flowchart illustrating a communication method in an in-vehicle network according to an embodiment of the present invention.

Referring to FIG. 21, in the communication method in an in-vehicle network according to an embodiment of the present invention, first, authentication information may be shared in advance at step S201.

That is, at step S201, an ECU on a transmission side and an ECU on a reception side may share authentication information in advance.

The authentication information may include a control value (a gap value), the number of messages to be created, a hash algorithm, a shared key, a dummy value, and the like.

Also, in the communication method in an in-vehicle network according to an embodiment of the present invention, whether data is changed may be determined at step S202.

That is, at step S202, the ECU on the transmission side may determine whether data collected from the in-vehicle network is changed based on a preset gap value.

Here, at step S202, it may be determined that the data is changed when the difference between the value of the data and the value of previously collected data is equal to or greater than the gap value.

Also, in the communication method in an in-vehicle network according to an embodiment of the present invention, a message may be created at step S203.

That is, at step S203, the ECU on the transmission side may create an authentication value based on the determination as to whether the data is changed, and may create a message including the data and the authentication value.

Here, at step S203, the authentication value is recreated only when it is determined that the data is changed, and a message including the recreated authentication value along with the changed data may be created.

Here, at step S203, when a number of messages equal to or greater than a preset number is created, the gap value may be changed to a preset next gap value.

Here, at step S203, the authentication value may be created by hashing the data using a hash algorithm shared in advance between the ECU on the transmission side and the ECU on the reception side.

Here, at step S203, the authentication value may be created from a value acquired by encrypting the data using a key shared in advance between the ECU on the transmission side and the ECU on the reception side.

Also, in the communication method in an in-vehicle network according to an embodiment of the present invention, the message may be transmitted to the ECU on the reception side at step S204.

Also, in the communication method in an in-vehicle network according to an embodiment of the present invention, the ECU on the reception side may receive the message from the ECU on the transmission side in the in-vehicle network at step S205.

Also, in the communication method in an in-vehicle network according to an embodiment of the present invention, the message may be verified at step S206.

That is, at step S206, a verification value is created using data extracted from the message, and the verification value is compared with the authentication value extracted from the message, whereby the integrity of the ECU on the transmission side may be verified.

Here, at step S206, whether an authentication value is included in the message is checked, and when an authentication value is included in the message, a verification value may be created.

Here, at step S206, the verification value may be created by hashing the data using a hash algorithm shared in advance between the ECU on the transmission side and the ECU on the reception side.

Here, at step S206, the verification value may be created from a value acquired by encrypting the data using a key shared in advance between the ECU on the transmission side and the ECU on the reception side.

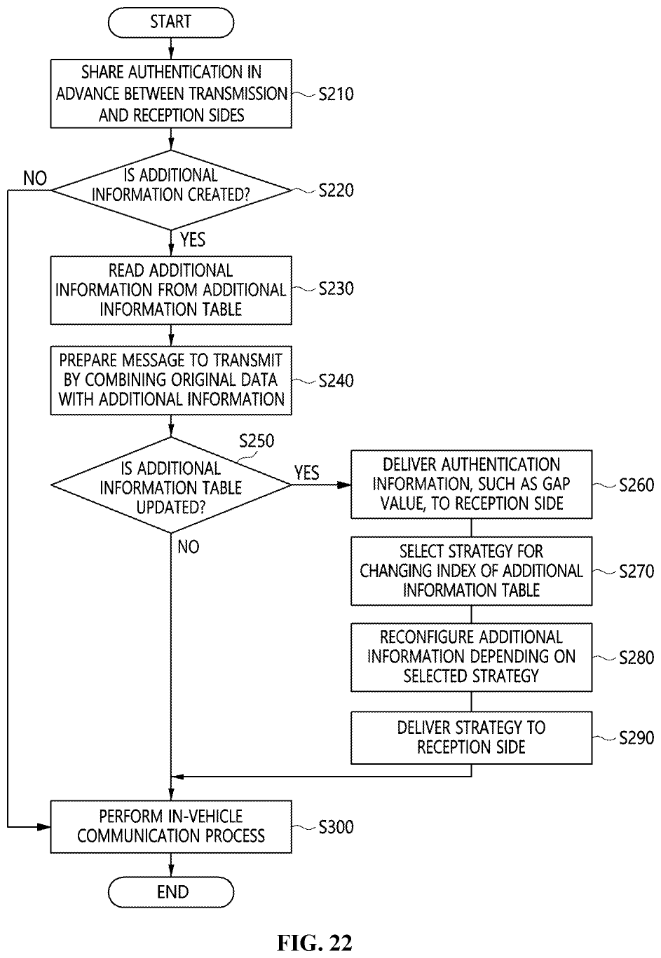

FIG. 22 is a flowchart illustrating a communication method of an ECU on a transmission side in an in-vehicle network according to an embodiment of the present invention.

Referring to FIG. 22, first, an ECU on a transmission side and an ECU on a reception side may share authentication information in advance at step S210.

The authentication information may include a control value (a gap value), the number of messages to be created, a hash algorithm, a shared key, a dummy value, and the like.

The ECU on the transmission side may determine whether data collected from the in-vehicle network is changed based on a preset gap value, and may create additional information at step S220.

That is, at step S220, when the difference between the value of the data and the value of previously collected data is equal to or greater than the gap value, it may be determined that the data is changed.

Here, at step S220, when it is determined that the data is changed, an authentication value, which is additional information, may be created at step S230, but when it is determined that the data is not changed, an in-vehicle communication process may be performed at step S300.

That is, at step S230, the ECU on the transmission side may create an authentication value based on the determination as to whether the data is changed.

Here, at step S230, additional information may be read from a table, in which the additional information, that is, authentication information shared in advance with the ECU on the reception side, is recorded.

Here, at step S230, when a number of messages equal to or greater than a preset number is created, the gap value may be changed to a preset next gap value.

Here, at step S230, the authentication value may be created by hashing the data using a hash algorithm shared in advance between the ECU on the transmission side and the ECU on the reception side.

Here, at step S230, the authentication value may be created from a value acquired by encrypting the data using a key shared in advance between the ECU on the transmission side and the ECU on the reception side.

The ECU on the transmission side may create a message including the data and the authentication value at step S240.

That is, at step S240, a message including the newly collected data and the newly created authentication value may be created.

Here, at step S240, the authentication value is recreated only when it is determined that the data is changed, and a message may be created by including the recreated authentication value along with the changed data.

The ECU on the transmission side may update the authentication information, which is the table in which the authentication value is recorded, using the updated authentication value at step S250.

That is, at step S250, when the authentication information is updated, the updated information may be transmitted to the ECU on the reception side at step S260, and when the authentication information is not updated, the in-vehicle communication process may be performed at step S300.

That is, at step S260, the updated authentication value, such as the gap value, may be delivered to the ECU on the reception side.

The ECU on the transmission side may select an authentication strategy, and may change indices in the table, which is the additional information, depending on the selected authentication strategy at step S270.

The ECU on the transmission side may reconfigure the table based on the changed indices at step S280.

The ECU on the transmission side may deliver the updated authentication information, which is the reconfigured table, to the ECU on the reception side at step S290.

The ECU on the transmission side may transmit the message to the ECU on the reception side, and may perform the in-vehicle communication process at step S300.

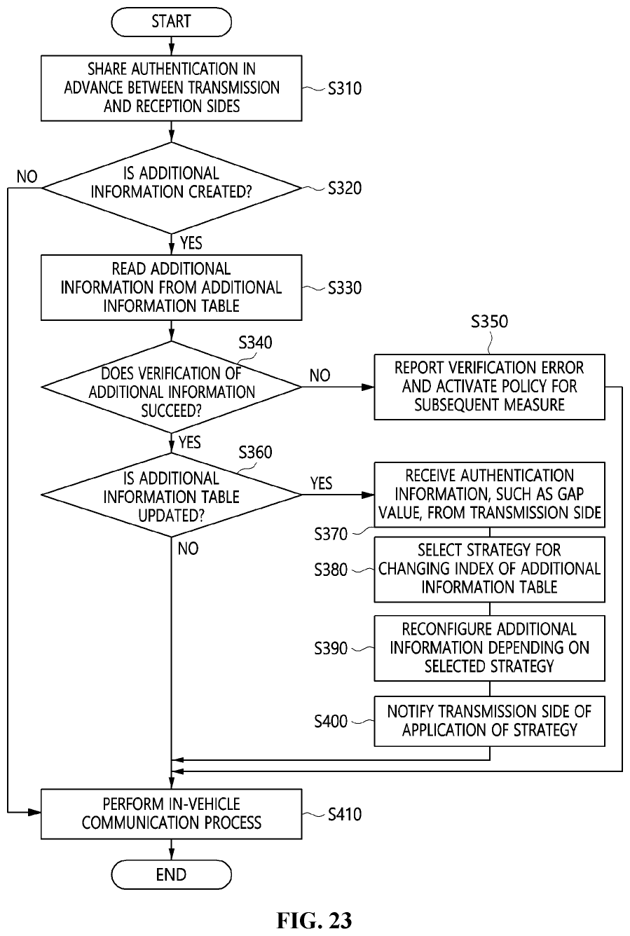

FIG. 23 is a flowchart illustrating a communication method of an ECU on a reception side in an in-vehicle network according to an embodiment of the present invention.

Referring to FIG. 23, first, an ECU on a transmission side and an ECU on a reception side may share authentication information in advance at step S310.

The authentication information may include a control value (a gap value), the number of messages to be created, a hash algorithm, a shared key, a dummy value, and the like.

The ECU on the reception side may determine whether data collected from the in-vehicle network is changed based on a preset gap value, and may create additional information at step S320.

That is, at step S320, the ECU on the reception side receives a message from the ECU on the transmission side in the in-vehicle network, and creates a verification value, which is additional information, at step S330 when the message includes an authentication value. However, when the message does not include an authentication value, the ECU on the reception side may perform an in-vehicle communication process at step S410.

The ECU on the reception side may create a verification value using data extracted from the message at step S330.

Here, at step S330, whether the message includes an authentication value is checked, and when the message includes an authentication value, a verification value may be created.

Here, at step S330, the verification value may be created by hashing the data using a hash algorithm shared in advance between the ECU on the transmission side and the ECU on the reception side.

Here, at step S330, the verification value may be created from a value acquired by encrypting the data using a key shared in advance between the ECU on the transmission side and the ECU on the reception side.

The ECU on the reception side reads additional information from a table, which is additional information shared in advance, and may verify the ECU on the transmission side using the authentication value included in the message and the verification value created thereby at step S340.

Here, at step S340, the ECU on the reception side verifies the integrity of the ECU on the transmission side by comparing the authentication value extracted from the message with the verification value, and updates the table at step S360 when the integrity verification succeeds. However, when the integrity verification fails, the ECU on the reception side may report a verification error and activate a policy for a subsequent measure at step S350.

At step S360, when verification of the integrity of the ECU on the transmission side succeeds, the ECU on the reception side may determine whether the table, which is additional information, is updated, and when it is necessary to update the table, the ECU on the reception side may receive the updated authentication information, such as the gap value, from the ECU on the transmission side at step S370. When it is not necessary to update the table, the ECU on the reception side may perform the in-vehicle communication process at step S410.

The ECU on the reception side may select an authentication strategy, and may change indices in the table, which is additional information, depending on the selected authentication strategy at step S380.

The ECU on the reception side may reconfigure the table based on the changed indices at step S390.

The ECU on the reception side may notify the ECU on the transmission side of application of the updated authentication information, which is the reconfigured table, at step S400.

The ECU on the reception side receives the message from the ECU on the transmission side, and may perform the in-vehicle communication process at step S410.

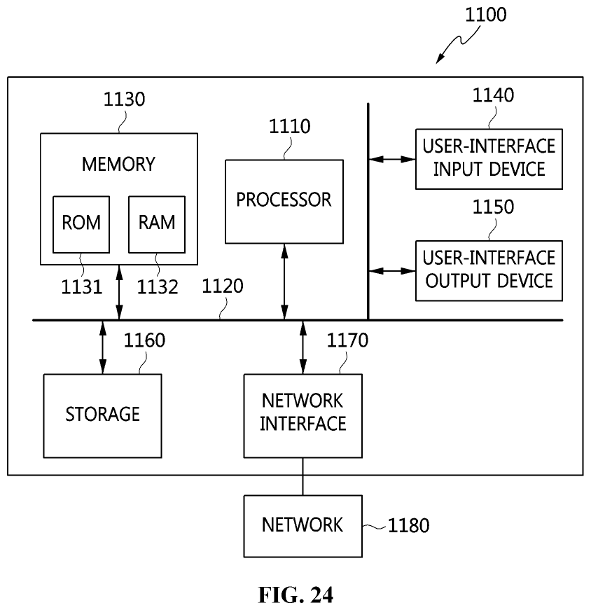

FIG. 24 is a view illustrating a computer system according to an embodiment of the present invention.

Referring to FIG. 24, the apparatus for communicating data in an in-vehicle network according to an embodiment of the present invention may be implemented in a computer system 1100 including a computer-readable recording medium. As illustrated in FIG. 24, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for communicating data on a transmission side in an in-vehicle network according to an embodiment of the present invention includes one or more processors 1110 and executable memory 1130 for storing at least one program executed by the one or more processors 1110. The at least one program determines whether data collected from the in-vehicle network is changed based on a preset gap value, creates an authentication value depending on the determination as to whether the data is changed, creates a message including the data and the authentication value, and transmits the message to an electronic control unit (ECU) on a reception side in the in-vehicle network.

Here, the at least one program may determine that the data is changed when the difference between the value of the data and the value of previously collected data is equal to or greater than the gap value.

Here, the at least one program may recreate the authentication value only when it determines that the data is changed, and may create a message by including the recreated authentication value along with the changed data.

Here, when a number of messages equal to or greater than a preset number is created, the at least one program may change the gap value to a preset next gap value.

Here, the at least one program may create the authentication value by hashing the data using a hash algorithm shared in advance with the ECU on the reception side.

Here, the at least one program may create the authentication value from a value acquired by encrypting the data using a key shared in advance with the ECU on the reception side.

Also, the apparatus for communicating data on a reception side in an in-vehicle network according to an embodiment of the present invention includes one or more processors 1110 and executable memory 1130 for storing at least one program executed by the one or more processors 1110. The at least one program may receive a message from an electronic control unit (ECU) on a transmission side in the in-vehicle network, create a verification value using data extracted from the message, and verify the integrity of the ECU on the transmission side by comparing the verification value with an authentication value extracted from the message.

Here, the at least one program may check whether the message includes an authentication value, and may create a verification value when the message includes an authentication value.

Here, the at least one program may create the verification value by hashing the data using a hash algorithm shared in advance with the ECU on the transmission side.

Here, the at least one program may create the verification value from a value acquired by encrypting the data using a key shared in advance with the ECU on the transmission side.

The apparatus and method for communicating data in an in-vehicle network according to an embodiment of the present invention may enable secure communication to be easily performed at low cost, and may increase profits by reducing product manufacturing costs from the standpoint of vehicle manufacturers.

Also, the apparatus and method for communicating data in an in-vehicle network according to an embodiment of the present invention may securely maintain and manage a shared key, thereby providing high security even though a simple and low-cost security operation is used.

Also, the apparatus and method for communicating data in an in-vehicle network according to an embodiment of the present invention may provide backward compatibility, enabling application thereof even in an in-vehicle network environment configured with existing low-specification ECUs, without additional hardware or computationally expensive security operations (encryption), and may effectively operate in the same manner even in the recent Ethernet-based hybrid network environment without additional hardware or computationally expensive security operations.

The present invention may provide secure communication between devices connected to an in-vehicle network and a network service.

Also, the present invention may provide a low-cost communication environment between devices connected to an in-vehicle network.

As described above, the apparatus and method for communicating data in an in-vehicle network according to the present invention are not limitedly applied to the configurations and operations of the above-described embodiments, but all or some of the embodiments may be selectively combined and configured, so that the embodiments may be modified in various ways.

What is claimed is:

1. A method for communicating data in an in-vehicle network, performed by apparatuses for communicating data on a transmission side and a reception side in the in-vehicle network, the method comprising:
determining, by the apparatus on the transmission side, whether data collected from the in-vehicle network is changed based on a preset gap value;
creating, by the apparatus on the transmission side, an authentication value based on a determination as to whether the data is changed, creating, by the apparatus on the transmission side, a message including the data and the authentication value, and transmitting, by the apparatus on the transmission side, the message to the apparatus on the reception side;
receiving, by the apparatus on the reception side, the message from the apparatus on the transmission side in the in-vehicle network;
creating, by the apparatus on the reception side, a verification value using the data extracted from the message; and
verifying, by the apparatus on the reception side, integrity of the apparatus on the transmission side by comparing the authentication value extracted from the message with the verification value.

2. The method of claim 1, wherein:
determining whether the data is changed is configured to determine that the data is changed when a difference between a value of the data and a value of previously collected data is equal to or greater than the gap value.

3. The method of claim 2, wherein:
transmitting the message is configured to recreate the authentication value only when the data is determined to be changed, and to create a message including the recreated authentication value along with the changed data.

4. The method of claim 3, wherein:
transmitting the message is configured to change the gap value to a preset next gap value when a number of messages equal to or greater than a preset number is created.

5. The method of claim 4, wherein:
transmitting the message is configured to create the authentication value by hashing the data using a hash algorithm shared in advance between the apparatus on the transmission side and the apparatus on the reception side.

6. The method of claim 4, wherein:
transmitting the message is configured to create the authentication value from a value acquired by encrypting the data using a key shared in advance between the apparatus on the transmission side and the apparatus on the reception side.

7. The method of claim 6, wherein:
creating the verification value is configured to check whether the message includes an authentication value and to create the verification value when the message includes the authentication value.

8. The method of claim 7, wherein:
creating the verification value is configured to create the verification value by hashing the data using a hash algorithm shared in advance between the apparatus on the transmission side and the apparatus on the reception side.

9. The method of claim 7, wherein:
creating the verification value is configured to create the verification value from a value acquired by encrypting the data using the key shared in advance between the apparatus on the transmission side and the apparatus on the reception side.

10. An apparatus for communicating data in an in-vehicle network, comprising:
one or more processors; and
executable memory for storing at least one program executed by the one or more processors,
wherein the at least one program is configured to:
determine whether data collected from the in-vehicle network is changed based on a preset gap value,
create an authentication value based on a determination as to whether the data is changed and create a message including the data and the authentication value, and
transmit the message to an Electronic Control Unit (ECU) on a reception side in the in-vehicle network.

11. The apparatus of claim 10, wherein:
the at least one program determines that the data is changed when a difference between a value of the data and a value of previously collected data is equal to or greater than the gap value.

12. The apparatus of claim 11, wherein:
the at least one program recreates the authentication value only upon determining that the data is changed, and creates the message including the recreated authentication value along with the changed data.

13. The apparatus of claim 12, wherein:
the at least one program changes the gap value to a preset next gap value when a number of messages equal to or greater than a preset number is created.

14. The apparatus of claim 13, wherein:
the at least one program creates the authentication value by hashing the data using a hash algorithm shared in advance with the ECU on the reception side.

15. The apparatus of claim 13, wherein:
the at least one program creates the authentication value from a value acquired by encrypting the data using a key shared in advance with the ECU on the reception side.

16. An apparatus for communicating data in an in-vehicle network, comprising:
one or more processors; and
executable memory for storing at least one program executed by the one or more processors,
wherein the at least one program is configured to:
receive a message from an Electronic Control Unit (ECU) on a transmission side in the in-vehicle network,
create a verification value using data extracted from the message, and verify integrity of the ECU on the transmission side by comparing the verification value with an authentication value extracted from the message.

17. The apparatus of claim 16, wherein:
the at least one program checks whether the message includes an authentication value, and creates the verification value when the message includes the authentication value.

18. The apparatus of claim 17, wherein:
the at least one program creates the verification value by hashing the data using a hash algorithm shared in advance with the ECU on the transmission side.

19. The apparatus of claim 17, wherein:
the at least one program creates the verification value from a value acquired by encrypting the data using a key shared in advance with the ECU on the transmission side.
